(19) United States
(12) Patent Application Publication
(10) Pub. No.: US 2021/0332243 A1
(43) Pub. Date: Oct. 28, 2021

(54) ENGINEERED COMPOSITE MATERIALS

(71) Applicant: Modern Meadow, Inc., Nutley, NJ (US)

(72) Inventors: Andras FORGACS, Montclair, NJ (US); Chi M. NG, Brooklyn, NY (US)

(21) Appl. No.: 17/271,289

(22) PCT Filed: Aug. 30, 2019
(86) PCT No.: PCT/US19/49136

§ 371 Date: Feb. 25, 2021

Related U.S. Application Data
(60) Provisional application No. 62/725,674, filed on Aug. 31, 2018.

(51) Int. Cl. C08L 89/06; C08L 99/00; C08J 5/12; B32B 7/12; B32B 7/09; B32B 9/02; B32B 9/04

(52) U.S. Cl. CPC C08L 89/06; C08L 99/00; C08J 5/127; C08J 5/128; B32B 7/12; B32B 7/09; B32B 2262/06; B32B 9/047; C08L 2205/16; C08L 2205/06; C08L 2205/03; C08J 2389/06; C08J 2399/00; B32B 9/02

(57) ABSTRACT

A composite material including mycelium fibers and proteins is described herein. The composite material can include a first protein substrate layer and a second mycelium layer, where the first and second layer are attached to each other. The composite material can include a first protein substrate layer, a second mycelium layer, and a third substrate layer, where the first layer and the second layer are attached to each other, and the second layer and third layer are attached to each other.

### FIELD

The present disclosure relates to engineered materials. In particular, the present disclosure relates to engineered materials having the look, feel, and other aesthetic properties of natural leather, the engineered materials comprising one or more proteins, such as collagen, and mycelium.

### BACKGROUND

Leather is used in a vast variety of applications, including furniture upholstery, clothing, shoes, luggage, handbag and accessories, and automotive applications. The estimated global trade value in leather is approximately US $100 billion per year (Future Trends in the World Leather Products Industry and Trade, United Nations Industrial Development Organization, Vienna, 2010). However, there exists a continuing and increasing demand for leather products. New ways to meet this demand are required in view of the economic, environmental and social costs of producing leather. To keep up with technological and aesthetic trends, producers and users of leather products seek new materials exhibiting uniformity of properties and easy processability, as well as fashionable and appealing aesthetic properties that incorporate natural components.

Commercially available artificial leathers or synthetic leathers are known, with examples including leatherette, pleather, E-leather, and the like. While these artificial leathers and synthetic leathers have been commercially successful, these products often feel cheap or are noticeably “fake.” As such, there remains a need for a new material exhibiting fashionable and appealing aesthetic properties that more closely resemble natural products and that incorporates natural components.

### BRIEF SUMMARY

The present disclosure is directed to engineered materials, particularly engineered composite materials including mycelium and proteins.

A first embodiment (1) of the present application is directed to a composite material comprising mycelium fibers and proteins.

In a second embodiment (2), the composite material according to the first embodiment (1) further comprises a lubricant.

In a third embodiment (3), the composite material according to the first embodiment (1) or the second embodiment (2) further comprises a resin selected from the group consisting of acrylic and urethane.

A fourth embodiment (4) of the present application is directed to a composite material comprising a first protein substrate layer and a second mycelium layer, where the first and second layer are attached to each other.

In a fifth embodiment (5), the first protein substrate layer of the fourth embodiment (4) comprises collagen.

In a sixth embodiment (6), the collagen in the composite material according to the fifth embodiment (5) is recombinant collagen.

In a seventh embodiment (7), the first protein substrate layer and the second mycelium layer of the composite material according to any of embodiments (4)-(6), are attached with an adhesive, and the adhesive is selected from the group consisting of hot melt adhesives, emulsion polymer adhesives, and combinations thereof.

In an eighth embodiment (8), the first protein substrate layer of the composite material according to any of embodiments (4)-(7) is a web of fibers.

In a ninth embodiment (9), the fibers of the composite material according to the eighth embodiment (8) include collagen.

In a tenth embodiment (10), the collagen of the composite material according to the ninth embodiment (9) is recombinant collagen.

In an eleventh embodiment (11), the first protein substrate layer and second mycelium layer of the composite material according to any of embodiments (4)-(10) are attached by needle-punching.

A twelfth embodiment (12) of the present application is directed to a composite material comprising a first protein substrate layer, a second mycelium layer, and a third substrate layer, where the first and second layers are attached to each other, and the second and third layers are attached to each other.

In a thirteenth embodiment (13), the first protein substrate layer of the composite material according to the twelfth embodiment (12) comprises collagen.

In a fourteenth embodiment (14), the collagen of the composite material according to the thirteenth embodiment (13) is recombinant collagen.

In a fifteenth embodiment (15), the third substrate layer of the composite material according to any of embodiments (12)-(14) comprises collagen.

In a sixteenth embodiment (16), the collagen of the composite material according to the fifteenth embodiment (15) is recombinant collagen.

In a seventeenth embodiment (17), the first protein substrate layer of the composite material according to any of embodiments (12)-(16) is attached to the second mycelium layer with an adhesive selected from the group consisting of hot melt adhesives, emulsion polymer adhesives, and combinations thereof.

In an eighteenth embodiment (18), the third substrate layer of the composite material according to any of embodiments (12)-(17) is attached to the second mycelium layer with an adhesive selected from the group consisting of hot melt adhesives, emulsion polymer adhesives, and combinations thereof.

### BRIEF DESCRIPTION OF THE DRAWINGS

The accompanying figures, which are incorporated herein, form part of the specification and illustrate embodiments of the present disclosure. Together with the description, the figures further serve to explain the principles of and to enable a person skilled in the relevant art(s) to make and use the disclosed embodiments. These figures are intended to be illustrative, not limiting. Although the disclosure is generally described in the context of these embodiments, it should be understood that it is not intended to limit the scope of the disclosure to these particular embodiments. In the drawings, like reference numbers indicate identical or functionally similar elements.

FIG. 1 illustrates a two-layer composite material according to some embodiments.

FIG. 2 illustrates a two-layer composite material according to some other embodiments.

FIG. 3 illustrates a three-layer composite material according to some embodiments.

### DETAILED DESCRIPTION

All methods and materials similar or equivalent to those described herein can be used in the practice or testing of the materials described herein, with suitable methods and materials being described herein. All publications, patent applications, patents, and other references mentioned herein are incorporated by reference in their entirety. In case of conflict, the present specification, including definitions, will control. Further, the materials, methods, and examples are illustrative only and are not intended to be limiting, unless otherwise specified.

### Definitions

Unless otherwise defined, all technical and scientific terms used herein have the same meaning as commonly understood by one of ordinary skill in the art to which this disclosure belongs. In case of conflict, the present specification, including definitions, will control.

When an amount, concentration, or other value or parameter is given as a range, or a list of upper and lower values, this is to be understood as specifically disclosing all ranges formed from any pair of any upper and lower range limits, regardless of whether ranges are separately disclosed. Where a range of numerical values is recited herein, unless otherwise stated, the range is intended to include the endpoints thereof, and all integers and fractions within the range. It is not intended that the scope of the present disclosure be limited to the specific values recited when defining a range.

Further, unless otherwise explicitly stated to the contrary, when one or multiple ranges or lists of items are provided, this is to be understood as explicitly disclosing any single stated value or item in such range or list, and any combination thereof with any other individual value or item in the same or any other list.

When the term “about” is used in describing a value or an end-point of a range, the disclosure should be understood to include the specific value or end-point referred to. Whether or not a numerical value or end-point of a range recites “about,” the numerical value or end-point of a range is intended to include two embodiments: one modified by “about,” and one not modified by “about.”

As used herein, the term “about” refers to a value that is within ±10% of the value stated. For example, about 3 kPa can include any number between 2.7 kPa and 3.3 kPa.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but can include other elements not expressly listed or inherent to such process, method, article, or apparatus.

Further, unless expressly stated to the contrary, “or” and “and/or” refers to an inclusive and not to an exclusive. For example, a condition A or B, or A and/or B, is satisfied by any one of the following: A is true (or present) and B is false (or not present), A is false (or not present) and B is true (or present), and both A and B are true (or present).

The use of “a” or “an” to describe the various elements and components herein is merely for convenience and to give a general sense of the disclosure. This description should be read to include one or at least one and the singular also includes the plural unless it is obvious that it is meant otherwise.

As used herein, the phrases “selected from the group consisting of,” “chosen from,” and the like include mixtures of the specified materials.

When a feature or element is herein referred to as being “on” another feature or element, it can be directly on the other feature or element or intervening features and/or elements can also be present. In contrast, when a feature or element is referred to as being “directly on” another feature or element, there are no intervening features or elements present. It will also be understood that, when a feature or element is referred to as being “connected,” “attached” or “coupled” to another feature or element, it can be directly connected, attached or coupled to the other feature or element or intervening features or elements can be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skilled in the art that references to a structure or feature that is disposed “adjacent” another feature can have portions that overlap or underlie the adjacent feature.

Spatially relative terms, such as “under,” “below,” “lower,” “over,” “upper,” and the like, can be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device can be otherwise oriented (rotated 90 degrees or at other orientations) and the spatially relative descriptors used herein interpreted accordingly. Similarly, the terms “upwardly,” “downwardly,” “vertical,” “horizontal,” and the like are used herein for the purpose of explanation only unless specifically indicated otherwise.

Although the terms “first” and “second” can be used herein to describe various features/elements, these features/elements should not be limited by these terms, unless the context indicates otherwise. These terms can be used to distinguish one feature/element from another feature/element. Thus, a first feature/element discussed below could be termed a second feature/element, and similarly, a second feature/element discussed below could be termed a first feature/element without departing from the teachings described herein.

As used herein, “grain texture” describes a leather-like texture which is aesthetically or texturally similar to the texture of a full grain leather, top grain leather, corrected grain leather (where an artificial grain has been applied), or coarser split grain leather texture. In some embodiments, the engineered materials described herein can be tuned to provide a fine grain, resembling the surface grain of a leather. The engineered leather like material can be embossed, debossed or formed over a textured surface and combinations thereof to provide aesthetic features in the engineered materials.

As used herein, “dehydrating” or “dewatering” describes a process of removing water from a mixture containing collagen fibrils and water, such as an aqueous solution, suspension, gel, or hydrogel containing fibrillated collagen. Water can be removed by filtration, evaporation, freeze-drying, solvent exchange, vacuum-drying, convection-drying, heating, irradiating or microwaving, or by other known methods for removing water. In addition, chemical crosslinking of collagen can be used to remove bound water from collagen by consuming hydrophilic amino acid residues such as lysine, arginine, and hydroxylysine among others. Acetone can also be used to quickly dehydrate collagen fibrils and can also remove water bound to hydrated collagen molecules.

As used herein “collagen” refers to the family of at least 28 distinct naturally occurring collagen types including, but not limited to collagen types I, II, III, IV, V, VI, VII, VIII, IX, X, XI, XII, XIII, XIV, XV, XVI, XVII, XVIII, XIX, and XX. The term collagen as used herein also refers to collagen prepared using recombinant techniques. The term collagen includes collagen, collagen fragments, collagen-like proteins, triple helical collagen, alpha chains, monomers, gelatin, trimers and combinations thereof. Recombinant expression of collagen and collagen-like proteins is known in the art (see, e.g., Bell, EP 1232182B1, Bovine collagen and method for producing recombinant gelatin; Olsen, et al., U.S. Pat. No. 6,428,978 and VanHeerde, et al., U.S. Pat. No. 8,188,230, incorporated by reference herein in their entireties) Unless otherwise specified, collagen of any type, whether naturally occurring or prepared using recombinant techniques, can be used in any of the embodiments described herein. That said, in some embodiments, the composite materials described herein can be prepared using Bovine Type I collagen.

Collagens are characterized by a repeating triplet of amino acids, -(Gly-X—Y)n-, so that approximately one-third of the amino acid residues in collagen are glycine. X is often proline and Y is often hydroxyproline. Thus, the structure of collagen may consist of three intertwined peptide chains of differing lengths. Different animals may produce different amino acid compositions of the collagen, which may result in different properties (and differences in the resulting leather). Collagen triple helices (also called monomers or tropocollagen) may be produced from alpha-chains of about 1050 amino acids long, so that the triple helix takes the form of a rod of about approximately 300 nm long, with a diameter of approximately 1.5 nm. In the production of extracellular matrix by fibroblast skin cells, triple helix monomers may be synthesized and the monomers may self-assemble into a fibrous form. These triple helices may be held together by electrostatic interactions (including salt bridging), hydrogen bonding, Van der Waals interactions, dipole-dipole forces, polarization forces, hydrophobic interactions, and covalent bonding. Triple helices can be bound together in bundles called fibrils, and fibrils can further assemble to create fibers and fiber bundles. In some embodiments, fibrils can have a characteristic banded appearance due to the staggered overlap of collagen monomers. This banding can be called “D-banding.” The bands are created by the clustering of basic and acidic amino acids, and the pattern is repeated four times in the triple helix (D-period). (See, e.g., Covington, A., Tanning Chemistry: The Science of Leather (2009)) The distance between bands can be approximately 67 nm for Type 1 collagen. These bands can be detected using diffraction Transmission Electron Microscope (TEM), which can be used to access the degree of fibrillation in collagen. Fibrils and fibers typically branch and interact with each other throughout a layer of skin. Variations of the organization or crosslinking of fibrils and fibers can provide strength to a material disclosed herein. In some embodiments, protein is formed, but the entire collagen structure is not triple helical. In certain embodiments, the collagen structure can be about 10%, about 15%, about 20%, about 25%, about 30%, about 35%, about 40%, about 45%, about 50%, about 55%, about 60%, about 65%, about 70%, about 75%, about 80%, about 85%, about 90%, about 95%, about 96%, about 97%, about 98%, about 99% or 100% triple helical.

Regardless of the type of collagen, all are formed and stabilized through a combination of physical and chemical interactions including electrostatic interactions (including salt bridging), hydrogen bonding, Van der Waals interactions, dipole-dipole forces, polarization forces, hydrophobic interactions, and covalent bonding often catalyzed by enzymatic reactions. For Type I collagen fibrils, fibers, and fiber bundles, its complex assembly is achieved in vivo during development and is critical in providing mechanical support to the tissue while allowing for cellular motility and nutrient transport.

Various distinct collagen types have been identified in vertebrates, including bovine, ovine, porcine, chicken, and human collagens. Generally, the collagen types are numbered by Roman numerals, and the chains found in each collagen type are identified by Arabic numerals. Detailed descriptions of structure and biological functions of the various different types of naturally occurring collagens are generally available in the art; see, e.g., Ayad et al. (1998) The Extracellular Matrix Facts Book, Academic Press, San Diego, Calif.; Burgeson, R E., and Nimmi (1992) “Collagen types: Molecular Structure and Tissue Distribution” in Clin. Orthop. 282:250-272; Kielty, C. M. et al. (1993) “The Collagen Family: Structure, Assembly And Organization In The Extracellular Matrix,” Connective Tissue And Its Heritable Disorders, Molecular Genetics, And Medical Aspects, Royce, P. M. and B. Steinmann eds., Wiley-Liss, NY, pp. 103-147; and Prockop, D. J- and K. I. Kivirikko (1995) “Collagens: Molecular Biology, Diseases, and Potentials for Therapy,” Annu. Rev. Biochem., 64:403-434.)

Type I collagen is the major fibrillar collagen of bone and skin, comprising approximately 80-90% of an organism's total collagen. Type I collagen is the major structural macromolecule present in the extracellular matrix of multicellular organisms and comprises approximately 20% of total protein mass. Type I collagen is a heterotrimeric molecule comprising two α1(I) chains and one α2(I) chain, encoded by the COL1A1 and COL1A2 genes, respectively. Other collagen types are less abundant than type I collagen, and exhibit different distribution patterns. For example, type II collagen is the predominant collagen in cartilage and vitreous humor, while type III collagen is found at high levels in blood vessels and to a lesser extent in skin.

Type II collagen is a homotrimeric collagen comprising three identical α1(II) chains encoded by the COL2A1 gene. Purified type II collagen may be prepared from tissues by, methods known in the art, for example, by procedures described in Miller and Rhodes (1982) Methods In Enzymology 82:33-64.

Type III collagen is a major fibrillar collagen found in skin and vascular tissues. Type III collagen is a homotrimeric collagen comprising three identical α1(III) chains encoded by the COL3A1 gene. Methods for purifying type III collagen from tissues can be found in, for example, Byers et al. (1974) Biochemistry 13:5243-5248; and Miller and Rhodes, supra.

Type IV collagen is found in basement membranes in the form of sheets rather than fibrils. Most commonly, type IV collagen contains two α1(IV) chains and one α2(IV) chain. The particular chains comprising type IV collagen are tissue-specific. Type IV collagen may be purified using, for example, the procedures described in Furuto and Miller (1987) Methods in Enzymology, 144:41-61, Academic Press.

Type V collagen is a fibrillar collagen found in, primarily, bones, tendon, cornea, skin, and blood vessels. Type V collagen exists in both homotrimeric and heterotrimeric forms. One form of type V collagen is a heterotrimer of two α1(V) chains and one α2(V) chain. Another form of type V collagen is a heterotrimer of α1(V), α2(V), and α3(V) chains. A further form of type V collagen is a homotrimer of α1(V). Methods for isolating type V collagen from natural sources can be found, for example, in Elstow and Weiss (1983) Collagen Rel. Res. 3:181-193, and Abedin et al. (1982) Biosci. Rep. 2:493-502.

Type VI collagen has a small triple helical region and two large non-collagenous remainder portions. Type VI collagen is a heterotrimer comprising α1(VI), α2(VI), and α3(VI) chains. Type VI collagen is found in many connective tissues. Descriptions of how to purify type VI collagen from natural sources can be found, for example, in Wu et al. (1987) Biochem. J. 248:373-381, and Kielty et al. (1991) J. Cell Sci. 99:797-807.

Type VII collagen is a fibrillar collagen found in particular epithelial tissues. Type VII collagen is a homotrimeric molecule of three α1(VII) chains. Descriptions of how to purify type VII collagen from tissue can be found in, for example, Lunstrum et al. (1986) J. Biol. Chem. 261:9042-9048, and Bentz et al. (1983) Proc. Natl. Acad. Sci. USA 80:3168-3172. Type VIII collagen can be found in Descemet's membrane in the cornea. Type VIII collagen is a heterotrimer comprising two α1(VIII) chains and one α2(VIII) chain, although other chain compositions have been reported. Methods for the purification of type VIII collagen from nature can be found, for example, in Benya and Padilla (1986) J. Biol. Chem. 261:4160-4169, and Kapoor et al. (1986) Biochemistry 25:3930-3937.

Type IX collagen is a fibril-associated collagen found in cartilage and vitreous humor. Type IX collagen is a heterotrimeric molecule comprising α1(IX), α2(IX), and α3 (IX) chains. Type IX collagen has been classified as a FACIT (Fibril Associated Collagens with Interrupted Triple Helices) collagen, possessing several triple helical domains separated by non-triple helical domains. Procedures for purifying type IX collagen can be found, for example, in Duance, et al. (1984) Biochem. J. 221:885-889; Ayad et al. (1989) Biochem. J. 262:753-761; and Grant et al. (1988) The Control of Tissue Damage, Glauert, A. M., ed., Elsevier Science Publishers, Amsterdam, pp. 3-28.

Type X collagen is a homotrimeric compound of α1(X) chains. Type X collagen has been isolated from, for example, hypertrophic cartilage found in growth plates. (See, e.g., Apte et al. (1992) Eur J Biochem 206 (1): 217-24.)

Type XI collagen can be found in cartilaginous tissues associated with type II and type IX collagens, and in other locations in the body. Type XI collagen is a heterotrimeric molecule comprising α1(XI), α2(XI), and α3(XI) chains. Methods for purifying type XI collagen can be found, for example, in Grant et al., supra.

Type XII collagen is a FACIT collagen found primarily in association with type I collagen. Type XII collagen is a homotrimeric molecule comprising three α1(XII) chains. Methods for purifying type XII collagen and variants thereof can be found, for example, in Dublet et al. (1989) J. Biol. Chem. 264:13150-13156; Lunstrum et al. (1992) J. Biol. Chem. 267:20087-20092; and Watt et al. (1992) J. Biol. Chem. 267:20093-20099.

Type XIII is a non-fibrillar collagen found, for example, in skin, intestine, bone, cartilage, and striated muscle. A detailed description of type XIII collagen may be found, for example, in Juvonen et al. (1992) J. Biol. Chem. 267: 24700-24707.

Type XIV is a FACIT collagen characterized as a homotrimeric molecule comprising α1(XIV) chains. Methods for isolating type XIV collagen can be found, for example, in Aubert-Foucher et al. (1992) J. Biol. Chem. 267:15759-15764, and Watt et al., supra.

Type XV collagen is homologous in structure to type XVIII collagen. Information about the structure and isolation of natural type XV collagen can be found, for example, in Myers et al. (1992) Proc. Natl. Acad. Sci. USA 89:10144-10148; Huebner et al. (1992) Genomics 14:220-224; Kivirikko et al. (1994) J. Biol. Chem. 269:4773-4779; and Muragaki, J. (1994) Biol. Chem. 264:4042-4046.

Type XVI collagen is a fibril-associated collagen, found, for example, in skin, lung fibroblast, and keratinocytes. Information on the structure of type XVI collagen and the gene encoding type XVI collagen can be found, for example, in Pan et al. (1992) Proc. Natl. Acad. Sci. USA 89:6565-6569; and Yamaguchi et al. (1992) J. Biochem. 112:856-863.

Type XVII collagen is a hemidesmosal transmembrane collagen, also known at the bullous pemphigoid antigen. Information on the structure of type XVII collagen and the gene encoding type XVII collagen can be found, for example, in Li et al. (1993) J. Biol. Chem. 268(12):8825-8834; and McGrath et al. (1995) Nat. Genet. 11(1):83-86.

Type XVIII collagen is similar in structure to type XV collagen and can be isolated from the liver. Descriptions of the structures and isolation of type XVIII collagen from natural sources can be found, for example, in Rehn and Pihlajaniemi (1994) Proc. Natl. Acad. Sci USA 91:4234-4238; Oh et al. (1994) Proc. Natl. Acad. Sci USA 91:4229-4233; Rehn et al. (1994) J. Biol. Chem. 269:13924-13935; and Oh et al. (1994) Genomics 19:494-499.

Type XIX collagen is believed to be another member of the FACIT collagen family, and has been found in mRNA isolated from rhabdomyosarcoma cells. Descriptions of the structures and isolation of type XIX collagen can be found, for example, in Inoguchi et al. (1995) J. Biochem. 117:137-146; Yoshioka et al. (1992) Genomics 13:884-886; and Myers et al., J. Biol. Chem. 289:18549-18557 (1994).

Type XX collagen is a newly found member of the FACIT collagenous family, and has been identified in chick cornea. (See, e.g., Gordon et al. (1999) FASEB Journal 13: A1119; and Gordon et al. (1998), IOVS 39: S1128.)

The collagen can be naturally occurring or recombinant. The collagen can be non-human collagen. Suitable mammalian collagen include, but is not limited to, bovine, procine, kangaroo, alligator, crocodile, elephant, giraffe, zebra, llama, alpaca, lamb, dinosaur and combinations thereof. Collagen-like proteins can also be used.

Any type of collagen, truncated collagen, unmodified or post-translationally modified, or amino acid sequence-modified collagen that can be fibrillated and crosslinked by the methods described herein can be used to produce the engineered materials described herein. The degree of fibrillation of the collagen molecules can be determined via x-ray diffraction. This characterization will provide d-spacing values which will correspond to different periodic structures present (e.g., 67 nm spacing vs. amorphous). In some embodiments, the collagen can be substantially homogenous collagen, such as only Type I or Type III collagen or can contain mixtures of two or more different kinds of collagens. In embodiments, the collagen is recombinant collagen.

For example, a collagen composition can homogenously contain a single type of collagen molecule, for example 100% bovine Type I collagen or 100% Type III bovine collagen, or can contain a mixture of different kinds of collagen molecules or collagen-like molecules, such as a mixture of bovine Type I and Type III molecules. The collagen mixtures can include amounts of each of the individual collagen components in the range of about 1% to about 99%, including subranges. For example, the amounts of each of the individual collagen components within the collagen mixtures can be about 1%, about 10%, about 20%, about 30%, about 40%, about 50%, about 60%, about 70%, about 80%, about 90%, or about 99%, or within a range having any two of these values as endpoints. For example, in some embodiments, a collagen mixture can contain about 30% Type I collagen and about 70% Type III collagen. Or, in some embodiments, a collagen mixture can contain about 33.3% of Type I collagen, about 33.3% of Type II collagen, and about 33.3% of Type III collagen, where the percentage of collagen is based on the total mass of collagen in the composition or on the molecular percentages of collagen molecules.

### DESCRIPTION

Composite materials are disclosed herein. The composite materials include mycelium (also called mycelia herein). Mycelium is the vegetative part of a fungus or fungus-like bacterial colony, consisting of a mass of branching, thread-like hyphae. Fungi are composed primarily of a cell wall that is constantly being extended at the apex of the hyphae. Unlike the cell wall of a plant, which is composed primarily of cellulose, or the structural component of an animal cell, which relies on collagen, the structural oligosaccharides of the cell wall of fungi rely primarily on chitin and beta glucan. Chitin is a strong, hard substance, also found in the exoskeletons of arthropods.

In some embodiments, the mycelia can be grown, dehydrated, pressed, and heated to make a rigid material layer for forming an engineered composite material. Engineered composite materials described herein may be called “an engineered leather.” Alternatively, in some embodiments, the mycelia can be grown on fibers, one or more woven substrates, or one or more nonwoven substrates, to form a layer of a composite material. In some embodiments, the composite can be dehydrated, pressed, and/or heated after mycelium is grown thereon. In some embodiments, a mycelia layer can be laminated with other materials to form an engineered composite material. In some embodiments, it can be useful for at least one layer to have a grain texture. In some embodiments, the fibers on which the mycelia is grown can be selected from the group consisting of natural or synthetic woven fabrics, non-woven fabrics, knitted fabrics, mesh fabrics, spacer fabrics and the like. In some embodiments, the mycelia can be dissolved, mixed with a protein, such as collagen, formed into a material or coated onto another material and then dried.

Composite materials described herein include mycelium fibers and proteins, for example collagen. In some embodiments, the composite materials described herein include mycelium fibers and collagen. In some embodiments, the collagen is recombinant collagen. In some embodiments, the composite materials can include a lubricant. Exemplary lubricants include, but are not limited to, a fat, other hydrophobic compounds, or any material that modulates or controls fibril-fibril bonding during dehydration. In some embodiments, the composite materials can include a polymeric resin. Exemplary polymeric resins, include but are not limited to, acrylic resins and urethane resins. The composite materials can be single-layer or multi-layer materials.

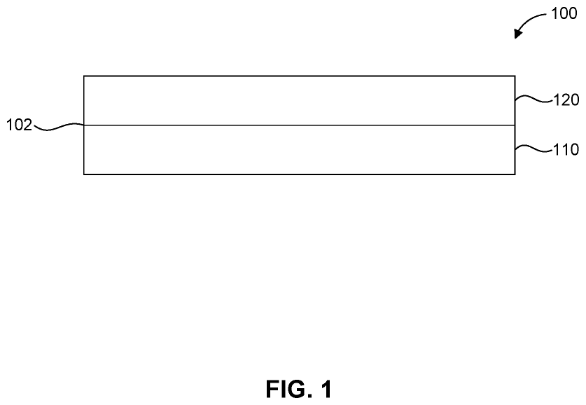

In some embodiments, for example as shown in FIG. 1, a composite material 100 can include a substrate layer 110 and a mycelium layer 120 attached to the substrate layer 100. In some embodiments, mycelium layer 120 can be attached to substrate layer 110 with an adhesive 102. In some embodiments, adhesive 102 can be a hot melt adhesive, an emulsion polymer adhesive, or a combination thereof. In some embodiments, mycelium layer 120 can be attached to substrate layer 110 using needle-punching. As used herein, a “mycelium layer” is a layer comprising mycelium. In some embodiments, a mycelium layer can include only mycelium.

Substrate layer 110 can be a protein layer (i.e., “a protein substrate layer”). As used herein, a “protein layer” is a layer comprising a protein. In some embodiments, a protein layer can include only protein. In some embodiments, the protein of substrate layer 110 can be collagen. In some embodiments, the collagen can be recombinant collagen. In some embodiments, substrate layer 110 can be collagen. In such embodiments, the collagen can be recombinant collagen. Thus, in some embodiments a material that can be laminated or attached to the mycelia is a collagen-based material. As used herein, “a collagen-based material” means a material comprising collagen.

In some embodiments, mycelia fibers are mixed with water and collagen to form a slurry for making a composite layer, which can be substrate layer 110. In some embodiments, the collagen in the composite layer can be recombinant collagen. The slurry can be lightly crosslinked and lubricants can be added to achieve a desired flexibility. The slurry can then precipitated, filtered, centrifuged, or otherwise dewatered, and dried to form a solid comprising fibers of mycelia bound together by collagen. Additional fibers including synthetic and/or natural fibers can also be added to the slurry.

In some embodiments, the collagen is dissolved in an aqueous solution, crosslinked, fatliquored and dewatered to make an engineered material forming substrate layer 110. The engineered material is combined with mycelium to form an engineered composite material. Examples of processes for producing a collagen-based material for use as a substrate layer are disclosed in WO 2019/017987, the entire contents of which are incorporated herein by reference. In some embodiments, the mycelia fibers can be incorporated into the collagen during the dewatering process. In other embodiments, the mycelia fibers can be processed as a separate layer and the resulting layers combined later.

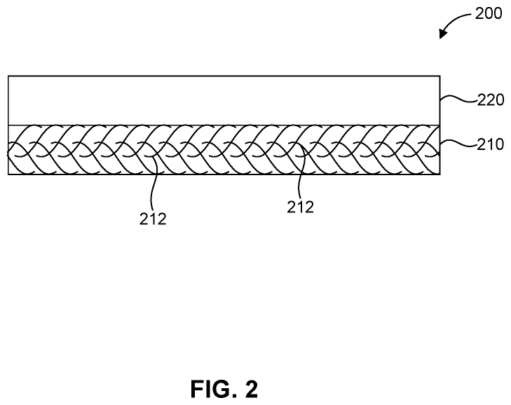

In some embodiments, for example as shown in FIG. 2, a composite material 200 can include a substrate layer 210 and a mycelium layer 220 attached to the substrate layer 210. In some embodiments, substrate layer 210 can include a web of fibers 212. In some embodiments, substrate layer can be a protein layer (i.e., “a protein substrate layer”). In some embodiments, fibers 212 can be collagen fibers. In some embodiments, fibers 212 can be recombinant collagen fibers. In some embodiments, a collagen solution, for example a collagen solution as described in WO 2019/017987 can be formed into fibers and converted into a material including nonwoven, woven, fabric, textile and the like. The material of substrate layer 210 can be attached to the mycelium layer 120 by needle-punching, laminating and the like.

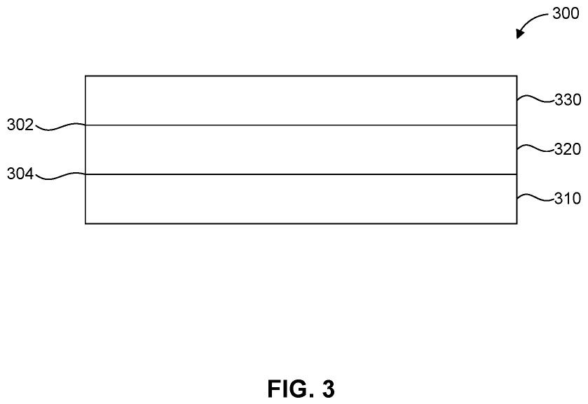

In some embodiments, for example as shown in FIG. 3, a composite material 300 can have a sandwich type structure formed using multiple layers wherein outer substrate layers 310 and 330 can be collagen-based substrate layers and the inner layer 320 can be mycelia. The outer substrate layers 310 and 330 can be composed of the same or different materials. For example, both can be collagen-based materials. As another example, one material can be a porous material and one material can be an elastic material. Collagen-based substrate layers can be the same as collagen-based substrate layers described above in connection with substrate layers 110 and 210. In some embodiments, the outer layers 310 and 330 can be mycelia and the inner layer 320 can be the collagen-based material.

In some embodiments, outer layers 310 and 330 can be attached to inner layer 320 by lamination. In some embodiments, the lamination can be accomplished with conventional adhesives, for example adhesives 302 and 304. Suitable adhesives include but are not limited to hot melt adhesives, emulsion polymer adhesives and the like. The mycelia can be coated with adhesive by known techniques such as slot die casting, kiss coating, and the like. The collagen-based material can be applied to the adhesive coated mycelia and passed through rollers under heat to laminate the materials or vice versa.

Alternatively, a collagen solution for example a collagen solution as described in WO 2019/017987 can be poured over a mycelia layer. After pouring, the composite material can be dried and heat pressed creating an engineered material with a grain like surface. In some embodiments, the collagen solution can penetrate through the mycelia layer creating a coextensive collagen-mycelia material.

Prior to dewatering the solution, the concentration of collagen can range from about 0.1 percent to about 3 percent by weight of the engineered material. In some embodiments, mycelia fibers can be added to the solution prior to dewatering. The concentration of mycelia fibers in the solution can range from about 0.01 percent to about 2 percent by weight of the solution. In some embodiments, after partially dewatering the solution, a concentrated solution of collagen can be obtained with the concentration of collagen ranging from about 5 percent to about 15 percent by weight of the solution.

In some embodiments, the water content of an engineered composite material after dehydration can be no more than about 60% by weight, for example, no more than about 5%, about 10%, about 15%, about 20%, about 30%, about 35%, about 40%, about 50%, or about 60% by weight of the engineered material. This range includes all intermediate values. Water content is measured by equilibration at 65% relative humidity at 25° C. and 1 atm. In the engineered material, the collagen content can be at least about 5%, for example about 10%, about 15%, about 20%, or about 30%, by the total weight of the material, or within a range having any two of these values as endpoints, inclusive of the endpoints. Engineered materials with zonal properties are taught in US Patent Application Pub. No. 2019/0144957, which is hereby incorporated by reference in its entirety. The zonal properties taught are applicable to the engineered materials described herein.

In some embodiments, a collagen solution can be fibrillated into collagen fibrils. As used herein, collagen fibrils refer to nanofibers composed of tropocollagen or tropocollagen-like structures (which have a triple helical structure). In some embodiments, triple helical collagen can be fibrillated to form nanofibrils of collagen. To induce fibrillation, the collagen can be incubated to form the fibrils for a time period in the range of about 1 minute to about 24 hours, including subranges. For example, the collagen can be incubated for about 1 minute, about 5 minutes, about 10 minutes, about 20 minutes, about 30 minutes, about 40 minutes, about 50 minutes, about 1 hour, about 2 hours, about 3 hours, about 4 hours, about 5 hours, about 6 hours, about 7 hours, about 8 hours, about 9 hours, about 10 hours, about 11 hours, about 12 hours, about 13 hours, about 14 hours, about 15 hours, about 16 hours, about 17 hours, about 18 hours, about 19 hours, about 20 hours, about 21 hours, about 22 hours, about 23 hours, or about 24 hours, or within a range having any two of these values as endpoints, inclusive of the endpoints.

In some embodiments, the collagen fibrils can have an average diameter in the range of about 1 nm (nanometer) to about 1 μm (micron, micrometer), including subranges. For example, and in some embodiments, the average diameter of the collagen fibrils can be about 1 nm, about 2 nm, about 3 nm, about 4 nm, about 5 nm, about 10 nm, about 15 nm, about 20 nm, about 30 nm, about 40 nm, about 50 nm, about 60 nm, about 70 nm, about 80 nm, about 90 nm, about 100 nm, about 200 nm, about 300 nm, about 400 nm, about 500 nm, about 600 nm, about 700 nm, about 800 nm, about 900 nm, or about 1 μm, or within a range having any two of these values as endpoints, inclusive of the endpoints. In some embodiments, an average length of the collagen fibrils can be in the range of about 100 nm to about 1 mm (millimeter), including subranges. For example, the average length of the collagen fibrils can be about 100 nm, about 200 nm, about 300 nm, about 400 nm, about 500 nm, about 600 nm, about 700 nm, about 800 nm, about 900 nm, about 1 μm, about 5 μm, about 10 μm, about 20 μm, about 30 μm, about 40 μm, about 50 μm, about 60 μm, about 70 μm, about 80 μm, about 90 μm, about 100 μm, about 200 μm, about 300 μm, about 400 μm, about 500 μm, about 600 μm, about 700 μm, about 800 μm, about 900 μm, or about 1 mm, or within a range having any two of these values as endpoints, inclusive of the endpoints.

In some embodiments, the density of the collagen fibrils in a substrate layer, for example substrate layer 110, can be in the range of about 1 mg/cc to about 1,000 mg/cc, including subranges. For example, the density of the collagen fibrils in a substrate layer can be about 5 mg/cc, about 10 mg/cc, about 20 mg/cc, about 30 mg/cc, about 40 mg/cc, about 50 mg/cc, about 60 mg/cc, about 70 mg/cc, about 80 mg/cc, about 90 mg/cc, about 100 mg/cc, about 150 mg/cc, about 200 mg/cc, about 250 mg/cc, about 300 mg/cc, about 350 mg/cc, about 400 mg/cc, about 450 mg/cc, about 500 mg/cc, about 600 mg/cc, about 700 mg/cc, about 800 mg/cc, about 900 mg/cc, or about 1,000 mg/cc, or within a range having any two of these values as endpoints, inclusive of the endpoints.

In some embodiments, the collagen fibrils can exhibit a unimodal, bimodal, trimiodal, or multimodal distribution. For example, a substrate layer can be composed of two different fibril preparations, each having a different range of fibril diameters arranged around one of two different modes. Such collagen mixtures can be selected to impart additive, synergistic, or a balance of physical properties to engineered materials described herein.

In some embodiments, the collagen fibrils can form networks. For example, individual collagen fibrils can associate to exhibit a banded pattern. These banded fibrils can then associate into larger aggregates of fibrils. However, in some embodiments, the fibrillated collagen can lack a higher order structure. For example, the collagen fibrils can be unbundled and provide a strong and uniform non-anisotropic structure to an engineered material. In other embodiments, the collagen fibrils can be bundled or aligned into higher order structures. For example, the collagen fibrils can have an orientation index in the range of 0 to about 1.0, including subranges. For example, the orientation index of the collagen fibrils can be 0, about 0.1, about 0.2, about 0.3, about 0.4, about 0.5, about 0.6, about 0.7, about 0.8, about 0.9, or about 1.0, or within a range having any two of these values as endpoints, inclusive of the endpoints. An orientation index of 0 describes collagen fibrils that are perpendicular to other fibrils, and an orientation index of 1.0 describes collagen fibrils that are completely aligned.

Further understanding can be obtained by reference to certain specific examples, which are provided herein for purposes of illustration only, and are not intended to be limiting unless otherwise specified.

### EXAMPLES

### Example 1

Type I collagen (10 grams) is dissolved in 1 L of 0.01N HCl, pH 2 using an overhead mixer. After the collagen is adequately dissolved, 111.1 mL of 10× phosphate buffer saline (pH adjusted to 11.2 with sodium hydroxide) is added to raise the pH of the solution to 7.2. The resulting collagen solution is stirred for 10 minutes and 0.1 mL of a 20% Relugan GTW (BASF) crosslinker solution is added, which is 2% of the weight of collagen, to fibrillate the collagen. 5 mL of 20% Tanigan FT (Lanxess) is added to the crosslinked collagen fibril solution, and is followed by stirring for one hour. Following the Tanigan-FT addition, 40 mL (80% on the weight of collagen) of Truposol Ben (Trumpler) and 2 mL (10% on the weight of collagen) of PPE White HSA (Stahl) is added and stirred for an additional hour using an overhead stirrer. The pH of the solution is lowered to 4.0 using 10% formic acid and is stirred for an hour. After the pH change, 150 mL of the solution is filtered through 90 μm Whatman No. 1 membrane using a Buchner funnel attached to a vacuum pump at a pressure of −27 mmHg. The concentrated fibril tissue is then allowed to dry under ambient conditions to produce an engineered material (12 inches×6 inches×⅛ inch).

A piece of heated and pressed mycelia (12 inches×6 inches×¼ inch) is laminated to the engineered material with an acrylic emulsion polymer adhesive to produce a first composite material.

### Example 2

A fibrillated, cross-linked, and fat liquored collagen paste is made by dissolving 10 g of collagen in 1 L of water with 0.1N HCl and is stirred overnight at 500 rpm. The pH is adjusted to 7.0 by adding 1 part 10× PBS to 9 parts collagen by weight, and the solution is stirred at 500 rpm for 3 hours. 10% tanning agent (by weight of collagen), e.g. glutaraldehyde is added and mixed for 20 mins. The pH is maintained above 7 by adding 20% sodium carbonate, and the solution is stirred overnight at 500 rpm. The following day, the fibrils are washed twice in a centrifuge and re-suspended to the proper volume and mixed at 350 rpm. Then the pH is adjusted to 7.0 with 10% formic acid or 20% sodium carbonate. 100% acrylic resin (by weight of collagen) is added and mixed for 30 mins. 100% offer of 20% fatliquor (by weight of collagen) is added and mixed for 30 mins. 10% microspheres (by weight of collagen) and 10% white pigment (by weight of collagen) are added and the pH is adjusted to 4.5 with 10% formic acid. Lastly, the solution is filtered and stirred each time the weight of the filtrate reaches 50% of the weight of the solution to produce a collagen paste.

A piece of heated and pressed mycelia (12 inches×6 inches×¼ inch) is placed on a flat surface. The collagen paste is poured onto the mycelia, spread out evenly to a thickness of ¼ inch and then hand rolled to pre-impregnate the paste into the mycelia to form a collagen coated mycelia. Then, the collagen coated mycelia is laid between two 15 cm×15 cm steel plates and placed in the hot press (from Carver) pre-set to 60° C., where it is pressed at 6,000 psi for 10 minutes. The collagen coated mycelia is removed and allowed to finish drying overnight to form a second composite material.

### Example 3

A piece of heated and pressed mycelia (12 inches×6 inches×¼ inch) is placed on a flat surface. A piece of fiber mat made of recombinant collagen fibers (12 inches×6 inches×⅛ inch) is placed on top of the mycelia. The two pieces of material are laid between two 15 cm×15 cm steel plates and placed in the hot press (from Carver) pre-set to 60° C., where it is pressed at 6,000 psi for 10 minutes to form a third composite material.

### Example 4

Another piece of the engineered material (6 inches×6 inches×¼ inch) from Example 1 is made, and additionally, another piece of the third composite material (6 inches×6 inches×⅜ inch) from Example 3 is made. The two materials are laminated together with acrylic emulsion polymer adhesive to produce a fourth composite material.

### Example 5

Another batch of the collagen paste from Example 2 is made. Another piece of the third composite material (6 inches×6 inches×⅜ inch) from Example 3 is made. The collagen paste is poured onto the third composite material, spread out evenly to a thickness of ¼ inch and then hand rolled to pre-impregnate the paste into the mycelia to form a collagen coated composite material. Then, the collagen coated composite material is laid between two 15 cm×15 cm steel plates and placed in the hot press (from Carver) pre-set to 60° C., where it is pressed at 6,000 psi for 10 minutes. The composite material is removed and allowed to finish drying overnight to produce a fifth composite material.

### Example 6

A web of entangled collagen fibers is spread and placed over an 8 inch by 12 inch surface. Another piece of heated and pressed mycelia (8 inches×12 inches×¼ inch) is placed on top of the web and passed through a needle-punch machine to form a sixth composite material.

### Example 7

A slurry of 2 grams of mycelia fibers is made in pH 4 water. The temperature is raised to 60° C. and held there for 60 minutes to allow for an appropriate degree of deacetylation to occur. The pH of the slurry is adjusted to 7 and then mixed with 200 mL of 10 g/L collagen solution in water. 10% of a tanning solution, for example glutaraldehyde, a blocked diisocyanate such as X-Tan from Lanxess, Tanigan-FT or similar reagent such as F-90, to co-react with the collagen and mycelia. Truposol Ben (Trumpler) is added to the slurry equaling to 80% by weight of collagen and 2 mL (10% on the weight of collagen) of PPE White HSA (Stahl) is added and stirred for an additional hour using an overhead stirrer. The pH of the solution is reduced to 4.0 using 10% formic acid and stirred for an hour. After pH change, 150 mL of the solution is filtered through 90 um Whatman No. 1 membrane using a Buchner funnel attached to a vacuum pump at a pressure of 27 mmHg. The concentrated fibril tissue is then allowed to dry under ambient conditions to produce an engineered material (12 inches×6 inches×⅛ inch).

### Example 8

A web of entangled collagen fibers is placed at the bottom of an 8 inch by 12 inch mold to form a collagen mat. Mycelium is introduced on top of the collagen mat and it is allowed to grow and integrate into the surface of the collagen. Once the surface is covered, the growth process is stopped. In this example, the mycelium creates a “grain layer” on top of a collagen corium.

### Example 9

A circle with a 4 inch diameter is cut from a piece of silicone rubber (¼ inch thick) and is laid on top of a piece of heated and pressed mycelia (measuring 10 inches×10 inches×¼ inch). The formulation of collagen paste from Example 2 is poured into a hole in the silicone mold and spread out evenly to a thickness of ¼ inch and then hand rolled to pre-impregnate the paste into the mycelia to form a zonally collagen coated mycelia. The collagen coated mycelia is laid between two 15 cm×15 cm steel plates and placed in a hot press (from Carver) pre-set to 60° C., where it is pressed at 6,000 psi for 10 minutes. The collagen coated mycelia is removed and allowed to finish drying overnight to form a material.

### Example 10

Mycelia is allowed to grow over a piece of cellulose fabric. The two layers are then heated and pressed creating a 12 inches×6 inches×¼ inch sheet, which is then laminated to the same type of engineered material, as described in Example 1, with an acrylic emulsion polymer adhesive to produce a material.

### Example 11

Mycelia is allowed to grow over a piece of cellulose fabric. The two layers are then heated and pressed creating a 12 inches×6 inches×¼ inch sheet. The sheet is placed on a flat surface. The collagen paste from Example 2 is poured onto the sheet, spread out evenly to a thickness of ¼ inch, and then hand rolled to pre-impregnate the paste into the sheet to form a collagen-coated sheet. The collagen-coated sheet is laid between two 15 cm×15 cm steel plates and placed in the hot press (Carver) pre-set to 60° C., where it is pressed at 6,000 psi for 10 minutes. The collagen coated sheet is removed and allowed to finish drying overnight to form a composite material.

Numerous modifications and variations on the present invention are possible in light of the above teachings. It is, therefore, to be understood that within the scope of the accompanying claims, the invention can be practiced otherwise than as specifically described herein.

In the context of the present description, all publications, patent applications, patents and other references mentioned herein, if not otherwise indicated, are explicitly incorporated by reference herein in their entirety for all purposes as if fully set forth, and shall be considered part of the present disclosure in their entirety.

The examples and illustrations included herein show, by way of illustration and not of limitation, specific embodiments in which the subject matter can be practiced. As mentioned, other embodiments can be utilized and derived there from, such that structural and logical substitutions and changes can be made without departing from the scope of this disclosure. Thus, although specific embodiments have been illustrated and described herein, any arrangement calculated to achieve the same purpose can be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The above description provides a manner and process of making and using it such that any person skilled in this art is enabled to make and use the same, this enablement being provided in particular for the subject matter of the appended claims, which make up a part of the original description. Various modifications to the embodiments described herein will be readily apparent to those skilled in the art, and the generic principles defined herein can be applied to other embodiments and applications without departing from the spirit and scope of the invention. Thus, this invention is not intended to be limited to the embodiments shown, but is to be accorded the widest scope consistent with the principles and features disclosed herein.

What is claimed is:

1. A composite material comprising: mycelium fibers and proteins.

2. The composite material of claim 1, further comprising a lubricant.

3. The composite material of claim 1 or 2, further comprising a resin selected from the group consisting of acrylic and urethane.

4. A composite material comprising:
a first protein substrate layer, and
a second mycelium layer; wherein the first and second layer are attached to each other.

5. The composite material of claim 4, wherein the first protein substrate layer comprises collagen.

6. The composite material of claim 5, wherein the collagen is recombinant collagen.

7. The composite material of any of claims 4-6, wherein the first protein substrate layer and the second mycelium layer are attached with an adhesive and the adhesive is selected from the group consisting of hot melt adhesives, emulsion polymer adhesives, and combinations thereof.

8. The composite material of any of claims 4-7, wherein the first protein substrate layer is a web of fibers.

9. The composite material of claim 8, wherein the fibers comprise collagen.

10. The composite material of claim 9, wherein the collagen is recombinant collagen.

11. The composite material of claims 4-10, wherein the first protein substrate layer and second mycelium layer are attached by needle-punching.

12. A composite material comprising;
a first protein substrate layer,
a second mycelium layer, and
a third substrate layer; wherein the first and second layers are attached to each other and the second and third layers are attached to each other.

13. The composite material of claim 12, wherein the first protein substrate layer comprises collagen.

14. The composite material of claim 13, wherein the collagen is recombinant collagen.

15. The composite material of any of claims 12-14, wherein the third substrate layer comprises collagen.

16. The composite of claim 15, wherein the collagen is recombinant collagen.

17. The composite material of any of claims 12-16, wherein the first protein substrate layer is attached to the second mycelium layer with an adhesive selected from the group consisting of hot melt adhesives, emulsion polymer adhesives, and combinations thereof.

18. The composite material of any of claims 12-17, wherein the third substrate layer is attached to the second mycelium layer with an adhesive selected from the group consisting of hot melt adhesives, emulsion polymer adhesives, and combinations thereof.
